(19) United States
(12) Patent Application Publication
(10) Pub. No.: US 2026/0160919 A1
(43) Pub. Date: Jun. 11, 2026

(54) METAL DETECTOR

(71) Applicant: SHANGHAI TIANXUN ELECTRONIC EQUIPMENT CO.,LTD, SHANGHAI (CN)

(72) Inventor: DAOXING GONG, SHANGHAI (CN)

(21) Appl. No.: 19/001,592

(22) Filed: Dec. 26, 2024

(30) Foreign Application Priority Data
Dec. 6, 2024 (CN) 202411802363.7

(51) Int. Cl. G01V 3/165; G01V 3/10

(52) U.S. Cl. CPC G01V 3/165; G01V 3/10

(57) ABSTRACT

A metal detector is provided, including a telescopic assembly, rotation locking mechanisms, a handle, and an arm brace. The detection coil is rotatably connected to and lockable to a bottom portion the telescopic assembly, The rotation locking mechanisms are disposed on an outer side of the telescopic assembly and are configured to block a length of the telescopic assembly, the handle and the arm brace are slidably disposed at an upper portion of the telescopic assembly, the handle partially extends through an interior of the arm brace, and the handle and the arm brace are respectively locked to an outer wall of the telescopic assembly through two cam locking mechanisms. The telescopic assembly is capable of rotating and locking relative to the detection coil while extending and retracting, and a position of the arm brace is also adjustable relative to the telescopic assembly.

### TECHNICAL FIELD

The present disclosure relates to a technical field of metal detectors, and in particular to a metal detector.

### BACKGROUND

Metal detectors are devices for detecting metal objects, a working principle of which is based on response of metals to electromagnetic fields. When each metal detector approaches a corresponding metal object, a magnetic field within each metal detector changes, thereby triggering each metal detector to emit an alarm or indication signal.

Current metal detectors each typically includes a device, such as an electromagnetic coil, for generating a magnetic field, a sensor for detecting a change in the magnetic field, and a signal processor. When one metal object enters a detecting range of a corresponding metal detector, the one metal object may interfere with a magnetic field generated by the corresponding metal detector, thereby changing the magnetic field. The sensor is configured to capture such change in the magnetic field and convert the change to an electrical signal for the signal processor to process, so that the corresponding metal detector finally triggering an alarm or display a location of the one metal object.

After research, it is found that Chinese patent publication No. CN209656903U discloses a metal detector, including a metal probe, a display module, a circuit board, a main housing, a battery compartment, a sealed bottom cover, metal detector buttons, and a soft rubber body. The metal probe, the display module, and the circuit board are disposed in the main housing, the metal probe is connected to the circuit board, the display module is connected to the circuit board, the metal detector buttons are disposed in the hollowed-out portions of the main housing, the battery compartment is disposed at a tail end of the main housing, while the other end of the main housing is connected to the sealed bottom cover, and the soft rubber body is in close contact with the main housing.

The Chinese patent publication No. CN209656903U has defects that the metal detector cannot achieve multi-angle adjustments on angle, length, and grip position, thereby limiting usability thereof.

### SUMMARY

The present disclosure aims to provide a metal detector to overcome defects in the prior art.

In order to achieve above aims, the present disclosure adopts following technical solutions.

The present disclosure provides the metal detector, including a detection coil, a telescopic assembly, rotation locking mechanisms, a handle, and an arm brace. The detection coil is rotatably connected to and lockable to a bottom portion the telescopic assembly, The rotation locking mechanisms are disposed on an outer side of the telescopic assembly and are configured to block a length of the telescopic assembly, the handle and the arm brace are slidably disposed at an upper portion of the telescopic assembly, the handle partially extends through an interior of the arm brace, and the handle and the arm brace are respectively locked to an outer wall of the telescopic assembly through two cam locking mechanisms.

Furthermore, the telescopic assembly includes a lower shaft, a first middle shaft, a second middle shaft, and an upper shaft. The lower shaft, the first middle shaft, the second middle shaft, and the upper shaft are slidably connected in sequence from bottom to top. Three rotation locking mechanisms are provided, the three rotation locking mechanisms are respectively disposed at a connection between the lower shaft and the first middle shaft, a connection between the first middle shaft and the second middle shaft, a connection between the second middle shaft and the upper shaft. An end cap is clamped at a top end of the upper shaft.

Furthermore, a first guiding rib and a second guiding rib are respectively disposed on an inner wall of the first middle shaft and an inner wall of the second middle shaft, the first guiding rib and the second guiding rib are symmetrical to each other and protrude outward. A length of the first guiding rib on the inner wall of the first middle shaft is smaller than a length of the first middle shaft, the first guiding rib is disposed on a middle portion and a lower portion of the inner wall of the first middle shaft. Third guiding ribs are respectively disposed on an inner wall of the upper shaft and an outer wall of the upper shaft.

Furthermore, the three rotation locking mechanisms are provided, the three rotation locking mechanisms include three locking rings, three outer rotation locking shafts, and three inner rotation locking shafts. The three inner rotation locking shafts are respectively fixed to an outer wall of the first middle shaft, an outer wall of the second middle shaft, and the outer wall of the upper shaft. The three outer rotation locking shafts are connected to outer walls of the three inner rotation locking shafts through threads, convex ribs are respectively disposed on inner bottom sides of the three outer rotation locking shafts, the three locking rings respectively define concave grooves on outer sides thereof for matching with the convex ribs respectively on the inner bottom sides of the three outer rotation locking shafts. The three locking rings are wedge-shaped, the three inner rotation locking shafts are respectively fitted to outer walls of the three locking rings through horn-shaped openings defined at bottom portions thereof.

Furthermore, silicone anti-slip sleeves are respectively fixed to outer walls of the three outer rotation locking shafts.

Furthermore, bushings are respectively disposed on an outer side of a top portion of the lower shaft, an outer side of a top portion of the first middle shaft, and an outer side of a top portion of the second middle portion, the bushings define guiding grooves on outer sides thereof for matching with the first guiding rib, the second guiding rib, and a corresponding third guiding rib.

Furthermore, a cross section of a top end of the lower shaft is circular, and a cross section of a top end of the first middle shaft are circular.

Furthermore, a first through hole is defined at an end portion of the lower shaft, second through holes are respectively defined at one side of the detection coil, a locking screw passes through the first through hole and the second through holes, a locking nut is threadedly connected to an end portion of the locking screw, and silicone gaskets are respectively disposed between the one side of the detection coil where the second through holes are defined and the end portion of the lower shaft where the first through hole is defined. The locking screw is “7”-shaped.

Furthermore, the handle and the arm brace are each fitted onto an outer wall of the upper shaft through holes respectively defined on inner walls thereof, with a clearance fit. Cross-sections of the holes are each matched with a cross section of the upper shaft. The two cam locking mechanisms include two pressing pieces and two cam locking levers, the two pressing pieces are respectively rotatably disposed on an inner wall of the handle and an inner wall of the arm brace, the two pressing pieces are in contact with and matched with the outer wall of the upper shaft, the two cam locking levers are respectively rotatably connected to one side of the handle and one side of the arm brace through positioning pins, the two cam locking levers are respectively in contact with and are matched with the two pressing pieces.

Furthermore, a positioning hole is defined on an inner wall of the handle, a controller is disposed on an inner wall of the positioning hole. The controller includes a user operation interface, a loudspeaker, a headphone jack, a battery, a processor, an operation panel, and a port for connecting to the detection coil. The handle includes a grip at one side thereof. A strap and a probe rod positioning piece are disposed on an outer wall of the arm brace.

Beneficial effects of the present disclosure are as following.

The metal detector is composed of five parts, the telescopic assembly is capable of rotating and locking relative to the detection coil while extending and retracting. Moreover, a position of the arm brace is also adjustable relative to the telescopic assembly, thereby enabling multi-angle adjustments on angle, length, and grip position of the metal detector, so as to improve convenience and flexibility of use of the metal detector.

The first guiding rib protrudes from the inner side of the first middle shaft, the second guiding rib protrudes from the inner side of the second middle shaft, a corresponding third guiding rib protrudes from an inner side of the upper shaft, the bushings are respectively disposed on the outer side of the top portion of the lower shaft, the outer side of the top portion of the first middle shaft, and the outer side of the top portion of the second middle portion for matching with the first guiding rib, the second guiding rib, and the corresponding third guiding rib, in this way, the first middle shaft, the second middle shaft, and the upper shaft are prevented from rotating relative to each other, thereby improving use stability of the metal detector.

After the lower shaft and the first middle shaft reach their minimum separation distance during a retraction process, the lower shaft and the first middle shaft rotate relative to each other. Upon extension, remaining sections of the lower shaft and the first middle shaft overlap, causing guiding ribs and the guiding grooves on the bushings to engage, thereby preventing any relative rotation. In this way, rotational adjustment is enabled while ensuring a more convenient locking operation.

### BRIEF DESCRIPTION OF DRAWINGS

FIG. 1 is a three-dimensional schematic diagram of a metal detector of the present disclosure.

FIG. 2 is a side schematic diagram of the metal detector in an extension state.

FIG. 3 is a side schematic diagram of the metal detector in a retracted state.

FIG. 4 is an exploded schematic diagram of the metal detector.

FIG. 5 is a side cross-sectional schematic diagram of the metal detector.

FIG. 6 is a cross-section schematic diagram of a rotation locking mechanism of the metal detector.

FIG. 7 is a schematic diagram of an interior of a telescopic assembly of the metal detector.

FIG. 8 is a schematic diagram of a third guiding rib on an outer wall of an upper shaft of the metal detector.

Reference numerals in the drawings: 10. detection coil; 11. locking screw; 12. locking nut; 13. silicone gasket; 20. telescopic assembly; 21. lower shaft; 22. first middle shaft; 23. second middle shaft; 24. upper shaft; 25. end cap; 30. rotation locking mechanism; 31. locking ring; 32. silicone anti-slip sleeve; 33. outer rotation locking shaft; 34. bushing; 35. inner rotation locking shaft; 40. handle; 41. grip; 42. pressing piece; 43. cam locking lever; 44. positioning pin; 50. arm brace; 51. strap; 52. probe rod positioning piece; 60. controller.

### DETAILED DESCRIPTION OF EMBODIMENTS

Technical solutions of the present disclosure are further described in detail below with reference to specific embodiments.

Embodiments of the present disclosure are described in detail below, and examples of the embodiments are shown in accompanying drawings, in which the same or similar reference numerals refer to the same or similar components or components with the same or similar functions throughout. The embodiments described below with reference to the accompanying drawings are exemplary and are merely used to explain the present disclosure, and should not be construed as limiting the present disclosure.

### First Embodiment

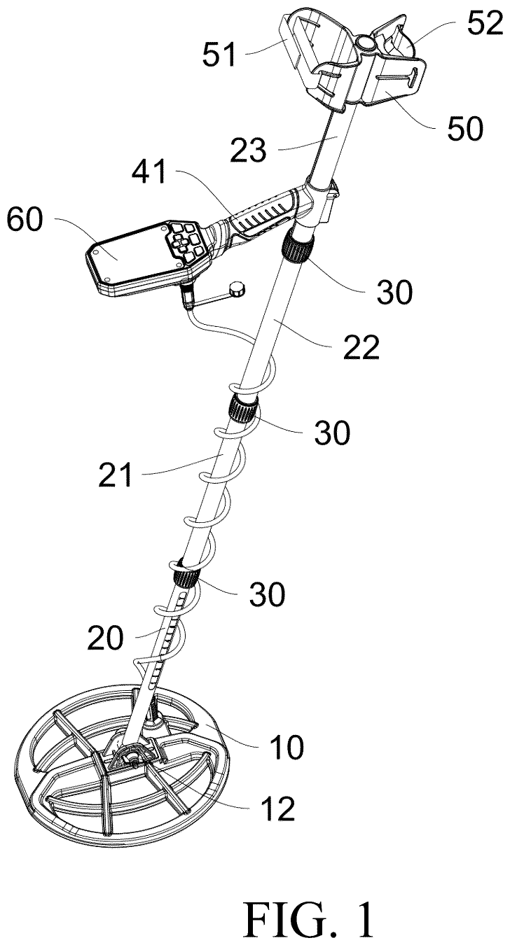

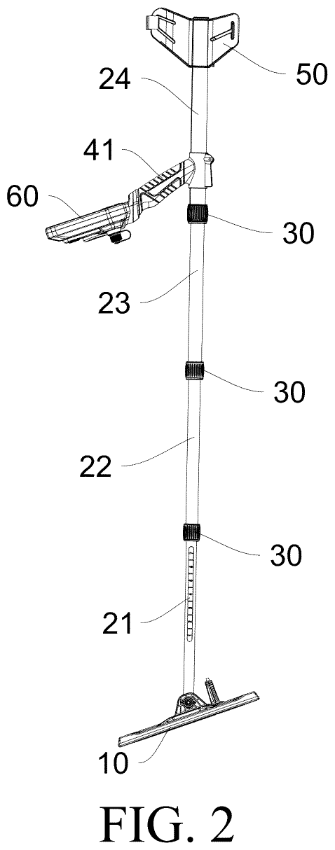

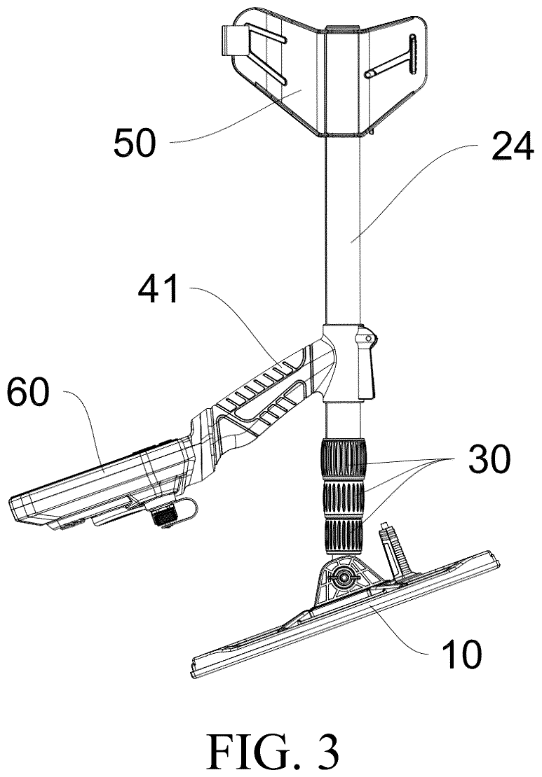

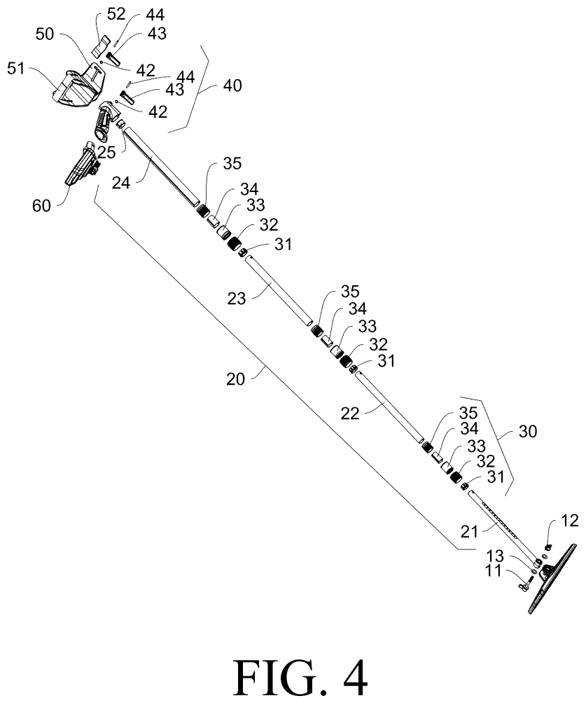

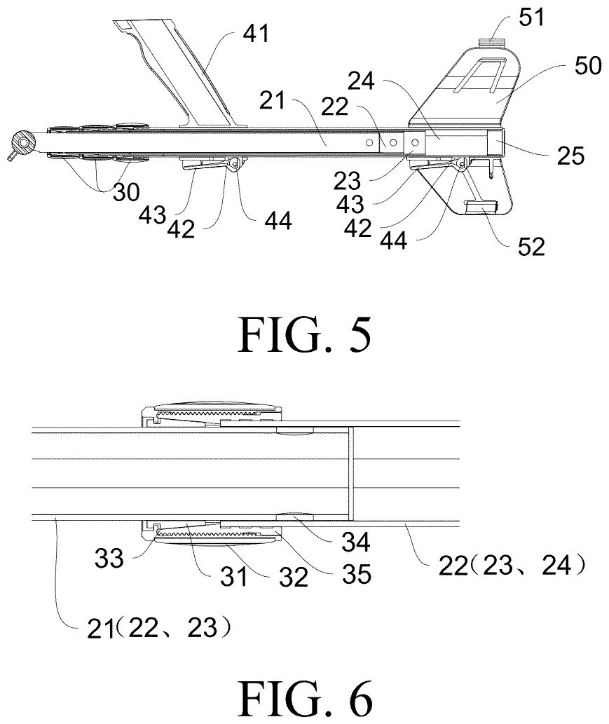

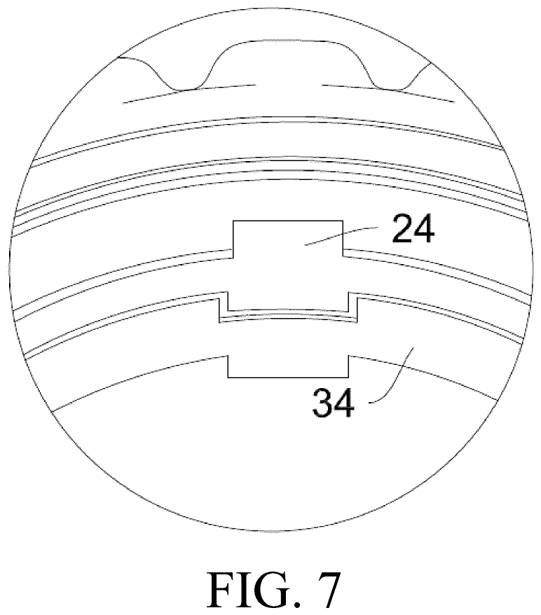

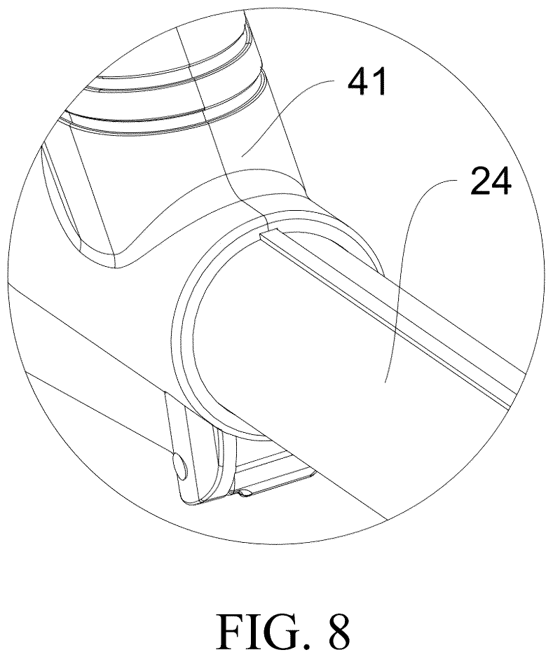

The present disclosure provides a metal detector, as shown in FIGS. 1-8, including a detection coil 10, a telescopic assembly 20, rotation locking mechanisms 30, a handle 40, and an arm brace 50. The detection coil 10 is rotatably connected to and lockable to a bottom portion the telescopic assembly 20, The rotation locking mechanisms 30 are disposed on an outer side of the telescopic assembly 20 and are configured to block a length of the telescopic assembly 20, the handle 40 and the arm brace 50 are slidably disposed at an upper portion of the telescopic assembly 20, the handle 40 partially extends through an interior of the arm brace 50, and the handle 40 and the arm brace 50 are respectively locked to an outer wall of the telescopic assembly through two cam locking mechanisms.

During use, the length of the telescopic assembly 20 is adjusted according to a height condition and usage habits of a user, so that an overall length of the metal detector is adjusted, after adjusting the length of the telescopic assembly 20, the telescopic assembly 20 is locked through the rotation locking mechanisms 30, then positions of the handle 40 and the arm brace 50 are adjusted, and after adjusting the positions of the handle 40 and the arm brace 50, one hand of the user cooperates with the arm brace 50 to perform metal detection.

The telescopic assembly 20 includes a lower shaft 21, a first middle shaft 22, a second middle shaft 23, and an upper shaft 24. The lower shaft 21, the first middle shaft 22, the second middle shaft 23, and the upper shaft 24 are slidably connected in sequence from bottom to top. Three rotation locking mechanisms 30 are provided, the three rotation locking mechanisms 30 are respectively disposed at a connection between the lower shaft 21 and the first middle shaft 22, a connection between the first middle shaft 22 and the second middle shaft 23, a connection between the second middle shaft 23 and the upper shaft 24. An end cap 25 is clamped at a top end of the upper shaft 24.

To address anti-torsion issues of the lower shaft 21, the first middle shaft 22, the second middle shaft 23, and the upper shaft 24, cross-sections of the lower shaft 21, the first middle shaft 22, the second middle shaft 23, and the upper shaft 24 are non-circular. In the embodiment, a first guiding rib and a second guiding rib are respectively disposed on an inner wall of the first middle shaft 22 and an inner wall of the second middle shaft 23, the first guiding rib and the second guiding rib are symmetrical to each other and protrude outward. A length of the first guiding rib on the inner wall of the first middle shaft 22 is smaller than a length of the first middle shaft 22, the first guiding rib is disposed on a middle portion and a lower portion of the inner wall of the first middle shaft 22. Third guiding ribs are respectively disposed on an inner wall of the upper shaft 24 and an outer wall of the upper shaft 24.

By configuring the lower shaft 21, the first middle shaft 22, the second middle shaft 23, and the upper shaft 24 with guiding ribs and bushings 34, mutual torsion between the lower shaft 21, the first middle shaft 22, the second middle shaft 23, and the upper shaft 24 are prevented.

To address locking issues, the three rotation locking mechanisms 30 are provided, the three rotation locking mechanisms 30 include three locking rings 31, three outer rotation locking shafts 33, and three inner rotation locking shafts 35. The three inner rotation locking shafts 35 are respectively fixed to an outer wall of the first middle shaft 22, an outer wall of the second middle shaft 23, and the outer wall of the upper shaft 24. The three outer rotation locking shafts 33 are connected to outer walls of the three inner rotation locking shafts 35 through threads, convex ribs are respectively disposed on inner bottom sides of the three outer rotation locking shafts 33, the three locking rings 31 respectively define concave grooves on outer sides thereof for matching with the convex ribs respectively on the inner bottom sides of the three outer rotation locking shafts 33. The three locking rings 31 are wedge-shaped, the three inner rotation locking shafts 35 are respectively fitted to outer walls of the three locking rings 31 through horn-shaped openings defined at bottom portions thereof.

Silicone anti-slip sleeves 32 are respectively fixed to outer walls of the three outer rotation locking shafts 33.

The bushings 34 are respectively disposed on an outer side of a top portion of the lower shaft 21, an outer side of a top portion of the first middle shaft 22, and an outer side of a top portion of the second middle portion 23, the bushings 34 define guiding grooves on outer sides thereof for matching with the first guiding rib, the second guiding rib, and a corresponding third guiding rib.

When the three outer rotation locking shafts 33 are not tightened, the three locking rings 31 do not engage with outer sides of the lower shaft 21, the first middle shaft 22, and the second middle shaft 23. At this point, the lower shaft 21 slides relative to the first middle shaft 22, the first middle shaft 22 slides relative to the second middle shaft 23, and the second middle shaft 23 slides relative to the upper shaft 24. When the lower shaft 21, the first middle shaft 22, and the second middle shaft 23 slide to corresponding limitation positions, the three locking rings 31 block the bushings 34 to prevent disengagement. To adjust a required length, the silicone anti-slip sleeves 32 are provided to rotate the three outer rotation locking shafts 33. Since the three outer rotation locking shafts 33 are connected to outer walls of the three inner rotation locking shafts 35 through the threads, axial movement is resulted between the three locking rings 31 and the three inner rotation locking shafts 35. The axial movement forces the horn-shaped openings of the three inner rotation locking shafts 35 to squeeze the wedge-shaped locking ring 31 inward against the outer wall of the lower shaft 21, the outer wall of the first middle shaft 22, and the outer wall of the second middle shaft 23, which uses friction to secure the lower shaft 21, the first middle shaft 22, and the second middle shaft 23.

A cross section of a top end of the first middle shaft 22 are circular and has no guiding rib. After the lower shaft 21 and the first middle shaft 22 reach their minimum separation distance during a retraction process, the lower shaft 21 and the first middle shaft 22 rotate relative to each other. Upon extension, remaining sections of the lower shaft 21 and the first middle shaft 22 overlap, causing guiding ribs and the guiding grooves to engage, thereby preventing any relative rotation.

A first through hole is defined at an end portion of the lower shaft 21, second through holes are respectively defined at one side of the detection coil 10, a locking screw 11 passes through the first through hole and the second through holes, a locking nut 12 is threadedly connected to an end portion of the locking screw 11, and silicone gaskets 13 are respectively disposed between the one side of the detection coil 10 where the second through holes are defined and the end portion of the lower shaft 21 where the first through hole is defined. The locking screw 11 is “7”-shaped.

When the locking screw 11 and the locking nut 12 are loosened, the detection coil 10 rotates relative to the lower shaft 21. When the locking screw 11 and the locking nut 12 are tightened, the silicone gaskets 13 is compressed, thereby using friction to secure the detection coil 10 to the lower shaft 21, preventing the detection coil 10 from rotating.

The handle 40 and the arm brace 50 are each fitted onto an outer wall of the upper shaft 24 through holes respectively defined on inner walls thereof, with a clearance fit. Cross-sections of the holes are each matched with a cross section of the upper shaft 24.

The two cam locking mechanisms include two pressing pieces 42 and two cam locking levers 43, the two pressing pieces 42 are respectively rotatably disposed on an inner wall of the handle 40 and an inner wall of the arm brace 50, the two pressing pieces 42 are in contact with and matched with the outer wall of the upper shaft 24. The two cam locking levers are respectively rotatably connected to one side of the handle 40 and one side of the arm brace 50 through positioning pins, the two cam locking levers 43 are respectively in contact with and are matched with the two pressing pieces 42.

When the two cam locking levers 43 rotate, protrusions on the two cam locking levers 43 limit movement of the two pressing pieces 42, so that the two pressing pieces 42 are in close contact with the outer wall of the upper shaft 24 to lock the handle 40 and the arm brace 50 with the upper shaft 24.

A positioning hole is defined on an inner wall of the handle 40, a controller 60 is disposed on an inner wall of the positioning hole. The controller 60 includes a user operation interface, a loudspeaker, a headphone jack, a battery, a processor, an operation panel, and a port for connecting to the detection coil 10.

The handle 40 includes a grip 41 at one side thereof.

A strap 51 and a probe rod positioning piece 52 are disposed on an outer wall of the arm brace 50.

During use, the length of the telescopic assembly 20 is adjusted according to the height condition and the usage habits of the user, so that the overall length of the metal detector is adjusted, after adjusting the length of the telescopic assembly 20, the telescopic assembly 20 is locked through the rotation locking mechanisms 30, then positions of the handle 40 and the arm brace 50 are adjusted, and after adjusting the positions of the handle 40 and the arm brace 50, the one hand of the user cooperates with the arm brace 50 to perform the metal detection. When the three outer rotation locking shafts 33 are not tightened, the three locking rings 31 do not engage with outer sides of the lower shaft 21, the first middle shaft 22, and the second middle shaft 23. At this point, the lower shaft 21 slides relative to the first middle shaft 22, the first middle shaft 22 slides relative to the second middle shaft 23, and the second middle shaft 23 slides relative to the upper shaft 24. When the lower shaft 21, the first middle shaft 22, and the second middle shaft 23 slide to corresponding limitation positions, the three locking rings 31 block the bushings 34 to prevent disengagement. To adjust a required length, the silicone anti-slip sleeves 32 are provided to rotate the three outer rotation locking shafts 33. Since the three outer rotation locking shafts 33 are connected to outer walls of the three inner rotation locking shafts 35 through the threads, axial movement is resulted between the three locking rings 31 and the three inner rotation locking shafts 35. The axial movement forces the horn-shaped openings of the three inner rotation locking shafts 35 to squeeze the wedge-shaped locking ring 31 inward against the outer wall of the lower shaft 21, the outer wall of the first middle shaft 22, and the outer wall of the second middle shaft 23, which uses friction to secure the lower shaft 21, the first middle shaft 22, and the second middle shaft 23. When the locking screw 11 and the locking nut 12 are loosened, the detection coil 10 rotates relative to the lower shaft 21. When the locking screw 11 and the locking nut 12 are tightened, the silicone gaskets 13 is compressed, thereby using friction to secure the detection coil 10 to the lower shaft 21, preventing the detection coil 10 from rotating. When the two cam locking levers 43 rotate, the protrusions on the two cam locking levers 43 limit the movement of the two pressing pieces 42, so that the two pressing pieces 42 are in close contact with the outer wall of the upper shaft 24 to lock the handle 40 and the arm brace 50 with the upper shaft 24.

The foregoing are merely preferred embodiments of the present disclosure, a protection scope of the present disclosure is not limited thereto, and those who skilled in the art may make equivalent replacements or changes according to technical solutions of the present disclosure and an inventive concept thereof within a technical scope disclosed by the present disclosure, which should be within the protection scope of the present disclosure.

What is claimed is:

1. A metal detector, comprising:
a detection coil;
a telescopic assembly;
rotation locking mechanisms;
a handle; and
an arm brace;
wherein the detection coil is rotatably connected to and lockable to a bottom portion the telescopic assembly, the rotation locking mechanisms are disposed on an outer side of the telescopic assembly and are configured to block a length of the telescopic assembly, the handle and the arm brace are slidably disposed at an upper portion of the telescopic assembly, the handle partially extends through an interior of the arm brace, and the handle and the arm brace are respectively locked to an outer wall of the telescopic assembly through two cam locking mechanisms.

2. The metal detector according to claim 1, wherein the telescopic assembly comprises a lower shaft, a first middle shaft, a second middle shaft, and an upper shaft;
the lower shaft, the first middle shaft, the second middle shaft, and the upper shaft are slidably connected in sequence from bottom to top;
three rotation locking mechanisms are provided, the three rotation locking mechanisms are respectively disposed at a connection between the lower shaft and the first middle shaft, a connection between the first middle shaft and the second middle shaft, a connection between the second middle shaft and the upper shaft; and
an end cap is clamped at a top end of the upper shaft.

3. The metal detector according to claim 2, wherein a first guiding rib and a second guiding rib are respectively disposed on an inner wall of the first middle shaft and an inner wall of the second middle shaft, the first guiding rib and the second guiding rib are symmetrical to each other and protrude outward;
a length of the first guiding rib on the inner wall of the first middle shaft is smaller than a length of the first middle shaft, the first guiding rib is disposed on a middle portion and a lower portion of the inner wall of the first middle shaft; and
third guiding ribs are respectively disposed on an inner wall of the upper shaft and an outer wall of the upper shaft.

4. The metal detector according to claim 1, wherein three rotation locking mechanisms are provided, the three rotation locking mechanisms comprise three locking rings, three outer rotation locking shafts, and three inner rotation locking shafts;
the three inner rotation locking shafts are respectively fixed to an outer wall of the first middle shaft, an outer wall of the second middle shaft, and an outer wall of the upper shaft;
the three outer rotation locking shafts are connected to outer walls of the three inner rotation locking shafts through threads, convex ribs are respectively disposed on inner bottom sides of the three outer rotation locking shafts, the three locking rings respectively define concave grooves on outer sides thereof for matching with the convex ribs respectively on the inner bottom sides of the three outer rotation locking shafts; and
the three locking rings are wedge-shaped, the three inner rotation locking shafts are respectively fitted to outer walls of the three locking rings through horn-shaped openings defined at bottom portions thereof.

5. The metal detector according to claim 4, wherein silicone anti-slip sleeves are respectively fixed to outer walls of the three outer rotation locking shafts.

6. The metal detector according to claim 3, wherein bushings are respectively disposed on an outer side of a top portion of the lower shaft, an outer side of a top portion of the first middle shaft, and an outer side of a top portion of the second middle portion, the bushings define guiding grooves on outer sides thereof for matching with the first guiding rib, the second guiding rib, and a corresponding third guiding rib.

7. The metal detector according to claim 2, wherein a cross section of a top end of the lower shaft is circular, and a cross section of a top end of the first middle shaft are circular.

8. The metal detector according to claim 2, wherein a first through hole is defined at an end portion of the lower shaft, second through holes are respectively defined at one side of the detection coil, a locking screw passes through the first through hole and the second through holes, a locking nut is threadedly connected to an end portion of the locking screw, and silicone gaskets are respectively disposed between the one side of the detection coil where the second through holes are defined and the end portion of the lower shaft where the first through hole is defined; and
the locking screw is “7”-shaped.

9. The metal detector according to claim 1, wherein the handle and the arm brace are each fitted onto an outer wall of the upper shaft through holes respectively defined on inner walls thereof, with a clearance fit;
cross-sections of the holes are each matched with a cross section of the upper shaft; and
the two cam locking mechanisms include two pressing pieces and two cam locking levers, the two pressing pieces are respectively rotatably disposed on an inner wall of the handle and an inner wall of the arm brace, the two pressing pieces are in contact with and matched with the outer wall of the upper shaft, the two cam locking levers are respectively rotatably connected to one side of the handle and one side of the arm brace through positioning pins, the two cam locking levers are respectively in contact with and are matched with the two pressing pieces.

10. The metal detector according to claim 1, wherein a positioning hole is defined on an inner wall of the handle, a controller is disposed on an inner wall of the positioning hole;
the controller comprises a user operation interface, a loudspeaker, a headphone jack, a battery, a processor, an operation panel, and a port for connecting to the detection coil;
the handle comprises a grip at one side thereof; and
a strap and a probe rod positioning piece are disposed on an outer wall of the arm brace.
